(19) United States
(12) Patent Application Publication
(10) Pub. No.: US 2024/0020352 A1
(43) Pub. Date: Jan. 18, 2024

(54) DYNAMIC SELECTION AND ENHANCEMENT OF IMAGES

(71) Applicant: META PLATFORMS, INC., Menlo Park, CA (US)

(72) Inventors: Leif Erik Foged, Seattle, WA (US); Pavan Kumar Paalya Chandrashekar, Sunnyvale, CA (US); Nahid Farahmand, Kirkland, WA (US)

(73) Assignee: META PLATFORMS, INC., Menlo Park, CA (US)

(21) Appl. No.: 17/180,053

(22) Filed: Feb. 19, 2021

(51) Int. Cl. G06K 9/62; G06F 40/279; G06K 9/46; G06K 9/00; G06F 3/0481; G06F 3/0484

(52) U.S. Cl. CPC G06K 9/6253; G06F 40/279; G06K 9/46; G06K 9/00624; G06F 3/0481; G06F 3/0484

(57) ABSTRACT

Systems, apparatuses and methods may provide for technology that identifies a plurality of images associated with a first listing and selects a first image from a plurality of images based on one or more of at least one engagement analysis signal or at least one image analysis signal. The at least one engagement analysis signal is associated with click-through rates of a first plurality of listings. The technology sets the first image as a representative image based on the selection of the first image, wherein the representative image represents the first listing.

### TECHNICAL FIELD

Embodiments generally relate to artificial intelligence (AI) based image analysis, enhancement and selection based on computer vision, and more specifically, to systems and methods for automated visual analysis using computer vision detection techniques to select and enhance images.

### BACKGROUND

With recent advances in computing technology, vast quantities of digital content are being distributed throughout the internet. Much of that digital content may be ignored because people have unique preferences and are attracted to different things. This may pose unique challenges for content providers and creators, and particularly to entities that host online listings.

### BRIEF DESCRIPTION OF THE DRAWINGS

The various advantages of the embodiments will become apparent to one skilled in the art by reading the following specification and appended claims, and by referencing the following drawings, in which:

FIG. 1 is a process of an example of image selection for a representation image according to an embodiment;

FIG. 2 is a process of an example of image selection and query process according to an embodiment;

FIG. 3 is a flowchart of an example of a method of periodically selecting a representative image according to an embodiment;

FIG. 4 is a flowchart of an example of a method of training a neural network according to an embodiment;

FIG. 5 is a flowchart of an example of a method of determining whether to update a representative image or bypass further analysis according to an embodiment;

FIG. 6 is a flowchart of an example of a method of selecting a representative image based on a user profile associated with a query according to an embodiment;

FIG. 7 is a flowchart of an example of a method of requesting new images from a user according to an embodiment;

FIG. 8 is a process of an example of selecting images according to an embodiment;

FIG. 9 is a block diagram of an example of a computing architecture according to an embodiment;

FIG. 10 is a flowchart of an example of a method of periodically updating a neural network training in real-time according to an embodiment;

FIG. 11 illustrates an example network environment associated with a social-networking system according to an embodiment;

FIG. 12 illustrates an example social graph according to an embodiment; and

FIG. 13 illustrates an example computer system according to an embodiment.

### DESCRIPTION OF EMBODIMENTS

A hosting entity (e.g., a computing device, server, mobile device, etc.) may be responsible for hosting listings. In response to a query, the hosting entity may provide one or more of the listings. In order to host the listings, the entity may consume a vast amount of computing resources that increases with the number of listings (which may number in the millions). For example, the hosting entity will consume storage space (e.g., memory, hard-drive space, solid-state drive) to store each listing. Thus, as the number of listings grows, storage space is negatively impacted to the point of being unsustainable.

Furthermore, the hosting entity may need to search through the listings in order to identify listings that are responsive to a query. As the number of listings increases, the search time and resources needed to search through the listings increases. That is, iterating through the listings to identify whether each listing is responsive to a query consumes processing resources, increases power consumption, and increases latency.

Furthermore, a user may conduct a search and the hosting entity may respond by providing a first set of listings to the user. If the user finds the first set of listings unacceptable, the user may request a second set of listings, and so forth until a satisfactory listing is located or the user ends the search. Requesting multiple sets of listings increases computing resources and consumes bandwidth. For example, processing power to search for and provide more listings increases, as well as consuming high levels of bandwidth to transmit further sets of listings. Furthermore, latency of the overall process increases since numerous listings must be searched for and transmitted.

Thus, providing listings in a fashion to facilitate understanding and recognition by a user increases the probability that the user will find one of the listings satisfactory to end the search and close a listing (e.g., remove the listing from storage after terms and conditions of the listing are satisfied). Doing so reduces the number of listings a user requests, reduces the number of compute resources needed to complete the search and reduces the overall storage space to maintain the listings since a lifetime of the listings is reduced.

Thus, minimizing the time that a listing remains open and reducing the number of listings requested by users beneficially reduces computing resources. As such, some embodiments relate to automatically selecting unique representative images of listings to minimize and/or reduce listing times. For example, selection of the representative image may be specifically designed to reduce an amount of time that a listing remains open and to reduce the number of listings a user requests. Doing so provides several technical enhancements, including reducing processing power for searches, an amount of storage space to host the listings (since more listings are closed at a faster rate), bandwidth to transmit numerous listings and reduces latency to reply to queries.

Doing so however may present unique challenges as a hosting entity may support millions of listings that each have a representative image. Thus, analyzing each listing and identifying representative images to represent each listing is impossible for a human to execute. Furthermore, a human being may not be able to discern a proper representative image from a plurality of images of a listing and incorrectly select images. For example, with millions of listings, some embodiments may identify image analysis signals and engagement signals of representative images of those listings that lead to users selecting the listings. Representative images for listings may be determined based on the identifications and based on numerous distinct analysis that would be impossible for a human to execute in real-time and to fully comprehend.

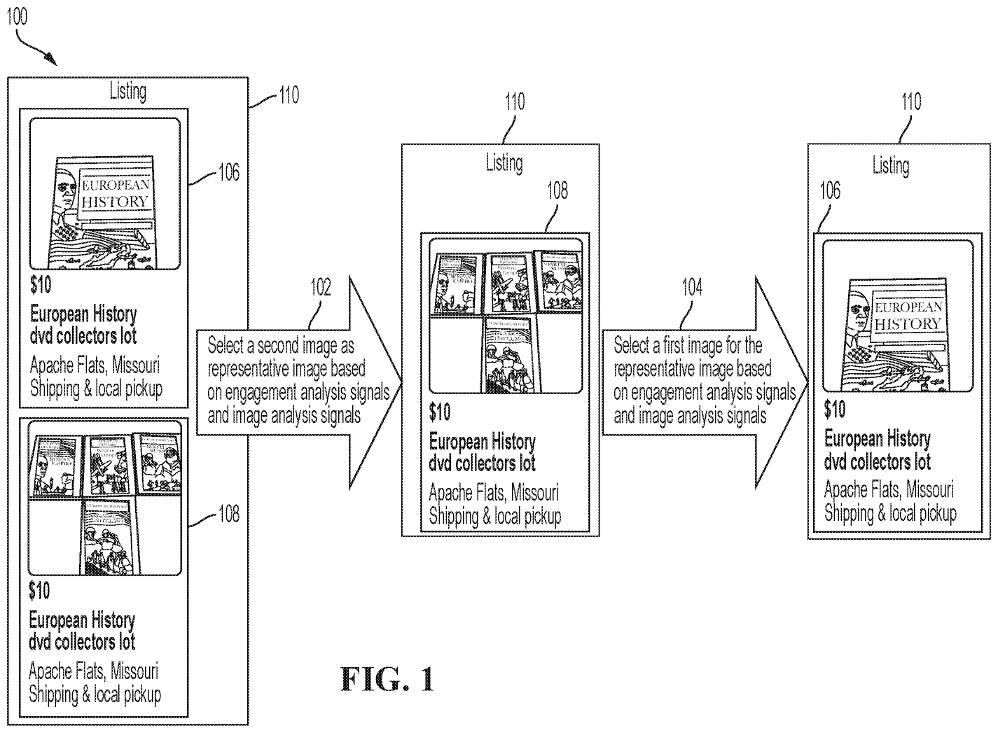

Turning to FIG. 1, an AI model (e.g., deep learning models, neural network, Convolutional Neural Networks, etc.) may implement an image selection process 100 to select an image to represent a listing. The process 100 may be implemented by a computing device, such as a server, computer, PC, mobile device, etc. (e.g., hardware, configurable logic, fixed-function logic hardware, at least one computer readable storage medium comprising a set of instructions for execution, etc.). In this example, a listing 110 may include a first image 106 and a second image 108.

The process 100 may identify which of the first and second images 106, 108 to select as a representative image for the listing 110. The representative image may be a representation of the listing 110 that is provided to users in response to queries. The representative image may be the default image that will be displayed (e.g., in thumbnail form) during searches and when the listing 110 appears in a list responsive to a query, a gallery view, collections, and is the image that will appear to represent the listing 110. The other image(s) of the listing 110 that are not the representative image will not be displayed unless the listing 110 is selected from the list. That is, the list may include a plurality of listings (e.g., entries), including the listing 110.

If the listing 110 is selected from the list, gallery view, and/or collection, the first and second images 106, 108 of the listing 110 may be displayed. As explained below, the representative image is the image of the first and second images 106, 108 deemed to be of the best quality and the best able to represent the listing 110 (e.g., an item for sale) to users. The representative image may not remain static, and may be opportunistically changed based on a factors including text of queries, time of day, geographic locations, click through rates (CTRs), impressions, etc. As noted above, proper selection of the representative image results in several technical enhancements to reduce overall computing resources and used bandwidth while increasing user satisfaction. Moreover, the selection of the representative image is a multi-dimensional selection process that occurs in real-time based on factors that are continuously updated based on real-time user feedback and analysis.

The process 100 may select the second image 108 as a representative image based on engagement analysis signals and image analysis signals 102. The engagement analysis signals may include different factors which affect user engagement with the first image 106 and the second image 108. The image analysis signals may be quality metrics associated with the first image 106 and the second image 108. Thus, the process 100 may select the second image 108 based on quality and predicted user engagement levels.

For example, the engagement analysis signals may include a time of day. Notably, different images may provide better user engagement at different times of the day. For example, a bright and well-lit picture may provide better user engagement in the daytime when a user is likely to be in a well-lit environment. A darker image may provide a better user engagement at nighttime when a user is more likely to be in a low lit environment. Thus, one of the user engagement signals may include a time of day.

Another engagement analysis signal may include an engagement metric that corresponds to actual tracking of engagement (e.g., click-throughs, time for viewing, etc.) of the first image 106 and the second image 108. In some embodiments, the engagement metrics may be correlated to the time of day. For example, a first set of engagement metrics (e.g., CTRs) may be generated in the morning, and thus be used to select a representative image in the morning while bypassing other sets of engagement metrics. A second set of engagement metrics (e.g., CTRs) may be generated in the afternoon, and thus be used to select a representative image in the afternoon while bypassing other sets of engagement metrics (e.g., the first engagement metrics). A third set of engagement metrics may be generated in the evening, and thus be used to select a representative image in the evening while bypassing other sets of engagement metrics (e.g., the first and second engagement metrics). In some embodiments, the engagement metrics are calculated during each time period and are not reliant on previous time periods and reset at the end of the time period.

For example, in some embodiments the listing 110 may be “live” and accessible by users. The process 100 may track how each of the first image 106 and the second image 108 is performing in real-time by a plurality of users. For example, the process 100 may identify how many times each of the first image 106 and the second image 108 is selected (e.g., accessed, clicked on, a CTR, etc.) for further viewing and/or for further enhancements (e.g., a user requests a higher quality image and/or a large sized image as opposed to a thumbnail). The process 100 may adjust the engagement analysis signals so as to be more likely to set the representative image to be one of the first image 106 and the second image 108 that is selected more frequently than other images. As an example, if the second image 108 has more selections (e.g., a higher CTR) than the first image 106 (e.g., has a lower CTR), the second image 108 may be selected as the representative image and/or more likely to be selected.

Another engagement metric may also relate to user impressions of the first and second images 106, 108. For example, users may optionally provide an impression (e.g., via one or more buttons on the page indicating whether a user likes or dislikes an image) of the first and second images 106, 108. An image from the first and second images 106, 108 with a more favorable impression may be more likely to be selected. The process 100 may adjust the engagement analysis signals so as to be more likely to set the representative image to be one of the first image 106 and the second image 108 that has a more favorable impression than other images. For example, if the second image 108 has an increased number of users indicating that the second image 108 is favorable (e.g., via the one or more buttons) relative to the first image 106, the second image 108 may have the more favorable impression and thus is more likely to be selected.

In some embodiments, the user impression may be determined based on interactions of users with the first and second images, 106, 108 distinct from a direct rating (e.g., like or dislike) by the users. For example, some embodiments may track how long a user views, stops at or otherwise interacts with each of the first and second images 106, 108. As an example, if the second image 108 has higher engagement metrics than the first image 106, the second image 108 may be selected and/or more likely to be selected. For example, if the second image 108 was viewed longer by users than the first image 106, it may be more likely that the second image 108 is selected.

The engagement analysis signals may further include a correspondence between text of the listing and objects in the first and second images 106, 108. For example, some embodiments may employ natural language processing (NLP) to identify objects from text (e.g., a product description) of the listing 110. Furthermore, some embodiments may identify objects in the first image 106 and the second image 108 with object recognition techniques (e.g., X-ray based analysis). If the text identifies several objects, the process 100 may select an image from the first and second images 106, 108 that includes all of the objects. If the objects are not in a single image of the first and second images 106, 108, the process 100 may identify and select one of the first and second images 106, 108 that includes the most objects.

The engagement analysis signals may also include a correspondence between the first and second images 106, 108 and a listed price of the listing 110. Some embodiments may select one of the first and second images 106, 108 based on a listed price. For example, a higher price may indicate that multiple objects are being sold, and the process 100 may identify and select one of the first and second images 106, 108 that includes the most objects.

The engagement analysis signals may also include a correspondence between the first and second images 106, 108 and geographic locations of users. For example, the process 100 may include identifying that a query originates from a certain geographic region, and adjusting the image selection process accordingly to provide a representative image in response to the query. For example, certain geographic regions may prefer different tones, colors and lighting.

The engagement analysis signals may also include a correspondence between the first and second images 106, 108 and demographics (e.g., age, gender, income, race, etc.) of querying users. For example, if a query is identified as originating from a first user within a first demographic, the process 100 may identify if other users from the first demographic preferred (e.g., as represented in the engagement metrics) the first image 106 or the second image 108 and adjust the selection process to weight selection to the preferred image. The preferred image may be set as the representative image and provided in response to the query. In some embodiments, a browsing history of the first user may also be analyzed and used to adjust the selection process. Notably, such a granular analysis (e.g., a user specific analysis) may enhance the process 100 by providing user specific results based not only on a query, but further based on demographics of the user.

The process 100 may further select the first image 106 for the listing 110 based on image analysis signals (e.g., visual aesthetics and appeal). For example, a first quality of the first image 106 and a second quality of the second image 108 may be analyzed and compared. If the first quality is higher than the second quality, the first image 106 may be more likely to be presented as the representative image than the second image 108. If however, the second quality is higher than the first quality, the second image 108 may be more likely to be presented as the representative image than the first image 106. The first quality and/the second quality may be related to brightness, clarity, contrast, whether objects are visible, whether inappropriate objects are visible, etc.

In the present example, the process 100 may select the second image 108 for as the representative image based on the engagement analysis signals and the image analysis signals 102. For example, the process 100 may predict the CTR of the first image 106 based on the engagement analysis signals and the image analysis signals. The process 100 may also predict the CTR of the second image 108 based on the engagement analysis signals and the image analysis signals. The process 100 predicts that the CTR of the second image 108 will be higher than the CTR of the first image 106 and select the second image 108 to be the representative image.

The process 100 may adjust weights, biases and inputs based on a multi-dimensional approach based on the factors described above (e.g., time of day, quality metrics, engagement metrics, query origin and/or demographics, etc.). As already described, the engagement analysis signals may include a plurality of different factors, and the image analysis signals may include an identification of the quality of the first image 106 and the second image 108. In some embodiments, the process 100 may further adjust characteristics of the second image 108 to enhance the perception of the second image 108 and provide emphasis on one or more objects in the second image 108.

The listing 110 with the second image 108 as the representative image (e.g., a thumbnail) may be transmitted to querying users in a list format that includes other listings. The list format may not include the first image 106 since the first image 106 is not set as the representative image. If the listing 110 is selected, the user may be presented with one or more of the first image 106 or the second image 108.

The process 100 may continue to execute after the second image 108 is selected as the representative image. For example, the process 100 may periodically determine whether the second image 108 should remain as the representative image, or whether the second image 108 should be replaced with another image. For example, it may be possible that the representative image changes during the course of the day and based on the engagement analysis signals and the image analysis signals (described above). For example, during a first time period, a first set of engagement metrics that correlate to the first time period may originally skew the analysis to select the second image 108. Thereafter during a second time period, a second set of engagement metrics that correlate to the second time period may skew the analysis to select the second image 108. Thus, the process 100 selects the first image 106 to be the representative image based on the engagement analysis signals and the image analysis signals 104. As such, the representative image may be dynamically selected and modified throughout the course of a day to reflect changing demographics of querying users, timings, geographic origination points, etc. Thus, some embodiments may substantially reduce a time that the listing remains active to reduce searching times, bandwidth needed to provide results and enhance and streamline data management.

Thus, some embodiments promote images that perform well. Moreover, some embodiments also take into account machine learning (ML)-based photo quality, visual aesthetics, and object identification (e.g., Xray) signals. Some embodiments may further rely on real-time photo engagement analysis signals.

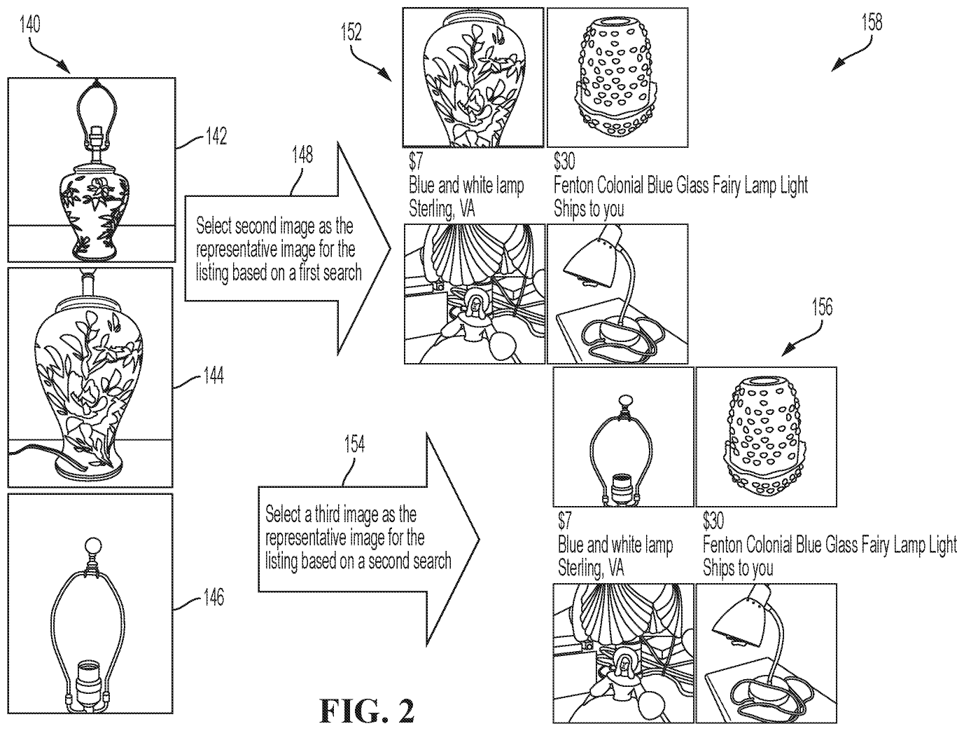

FIG. 2 illustrates an image selection and query process 158 to select representative images for a listing 140. One or more aspects of process 158 may be performed by and/or in conjunction with process 100 (FIG. 1). Process 158 may be implemented in a computing device, computing system (e.g., hardware, configurable logic, fixed-function logic hardware, at least one computer readable storage medium comprising a set of instructions for execution, etc.). The listing 140 includes three images, including a first image 142, a second image 144 and a third image 146.

The process 158 may select the second image 144 to be a representative image for the listing 140 based on a first search 148. The process 158 may select the second image 144 based on a first query associated with the first search. For example, the first query may specifically request a lamp with images of plants. Thus, the representative image may be determined based on an image that best matches the first query to include the plants. Other engagement analysis signals (e.g., a geographic location of the query) and image analysis signals may be analyzed to select the second image 144. The search results 152 responsive to the first query are shown as thumbnails of representative images for a plurality of listings (e.g., each thumbnail represents a different listing) and provided to a user device that originates the first query. If a user selects one of the thumbnails on the user device, a corresponding listing will be selected, and details of the corresponding listing (e.g., text and various images) will be presented to replace the thumbnails of the search results 152 on the user device.

The process 158 may further select the third image 146 for the listing 140 based on a second search 154. The process 158 may select the third image 146 based on a second query for the second search. For example, the second query may specifically request a lamp with a glass ball adornment. Notably, the glass ball adornment is not visible in the first image 142 or the second image 144, but is visible in the third image 146. If the first or second images 142, 144 were selected as the representative image, a user that originates the second query may never appreciate that the listing 140 includes a glass ball adornment and may bypass the listing 140.

Thus, the third image 146 may be determined to be the representative image based on the second search. Other engagement analysis signals (e.g., a geographic location of the second query) and image analysis signals may be analyzed to select the third image 146. The search results 156 responsive to the second query are shown as thumbnails of representative images for a plurality of listings (e.g., each thumbnail represents a different listing) and are provided to a user device that originates the second query. If a user selects one of the thumbnails on the user device, a corresponding listing will be selected, and details of the corresponding listing will be presented to replace the thumbnails of the search results 156 on the user device.

It is worthwhile to note that the second image 144 may be set as the representative image in response to an analysis of the first search and the third image 146 may be set as the representative image in response to an analysis of the second search during a same time period (e.g., concurrently, during morning, etc.). In some embodiments, the engagement metrics remain the same in the process 158 (e.g., first and second searches occur during a same time period).

Thus, the process 158 may dynamically adjust the process 158 to identify a representative image based on a specific query. Doing so may reduce searching times and provide more efficient results to a user.

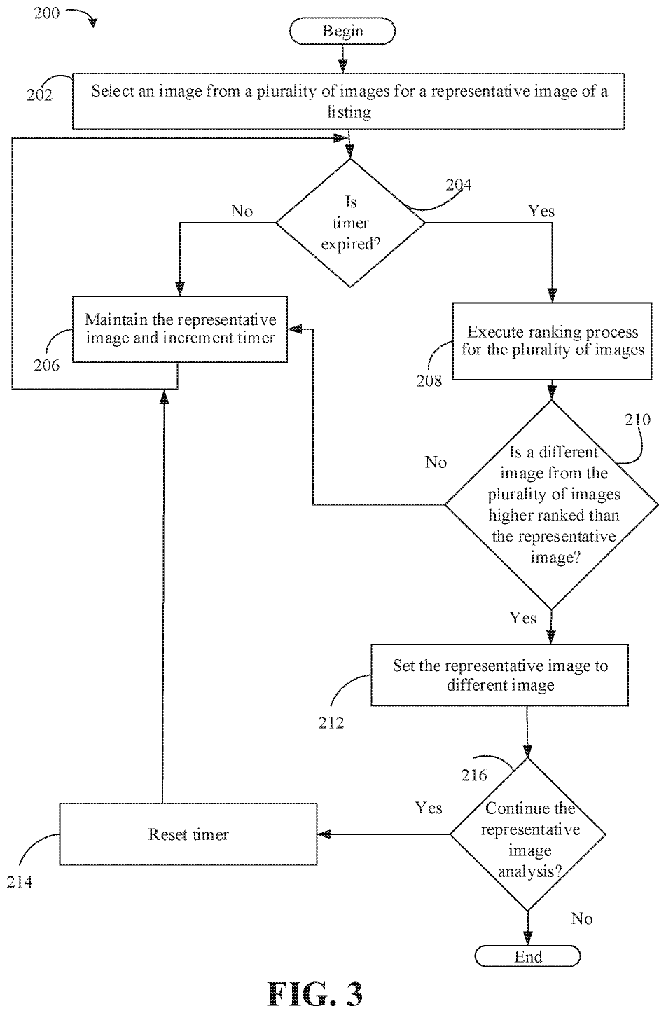

FIG. 3 illustrates a method 200 for periodically selecting a representative image. One or more aspects of method 200 may be performed by and/or in conjunction with process 100 (FIG. 1) and process 158 (FIG. 2) already discussed. Method 200 may be implemented in a computing device, computing system (e.g., hardware, configurable logic, fixed-function logic hardware, at least one computer readable storage medium comprising a set of instructions, etc.).

Illustrated processing 202 selects an image from a plurality of images for a representative image of a listing. The listing may include the plurality of images and an associated description. Illustrated processing block 204 determines if a timer has expired (e.g., if a predetermined time interval has been reached). If not, illustrated processing block 206 maintains the representative image and increments the timer. If the timer has expired, illustrated processing block 208 executes a ranking process for the plurality of images. The ranking process may be based on engagement analysis signals and image analysis signals as described herein.

Illustrated processing block 210 determines if a different image from the plurality of images is higher ranked than the representative image If not, illustrated processing block 206 executes. Otherwise, illustrated processing block 212 sets the representative image to the different image that is identified in processing block 210 to change the representative image. Illustrated processing block 216 determines whether to continue the representative image analysis (e.g., if the representative image has been consistently changed for a past few iterations, if a CTR of the listing is above a threshold, etc.). If so, illustrated processing block 214 resets the timer. Otherwise, method 200 may end.

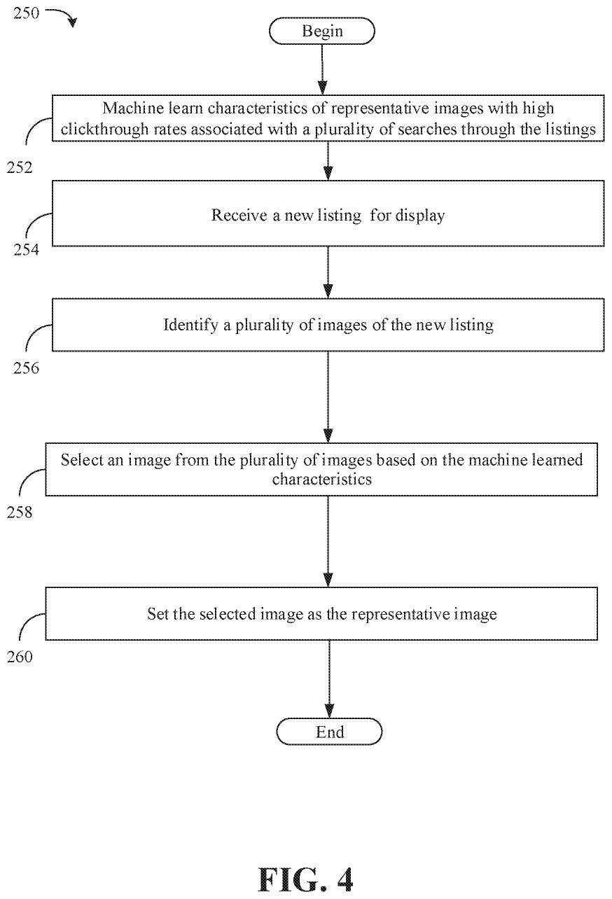

FIG. 4 illustrates a method 250 for training a neural network (e.g., a machine learning model) to select representative images. One or more aspects of method 200 may be performed by process 100 (FIG. 1), process 158 (FIG. 2) and/or method 200 (FIG. 3) already discussed. Method 250 may be implemented in a computing device, computing system (e.g., hardware, configurable logic, fixed-function logic hardware, at least one computer readable storage medium comprising a set of instructions for execution, etc.).

Illustrated processing block 252 machine learns characteristics of representative images of listings with high CTRs associated with a plurality of searches through the listings (e.g., in real time). For example, for each search, processing block 252 may identify images that are clicked on. Processing block 252 may machine learn based on the images with high CTRs during the searches. The machine learning model may include identifying engagement analysis signals and image analysis signals that correspond to high CTRs. Illustrated processing block 254 receives a new listing for display. Illustrated processing block 256 identifies a plurality of images for the new listing. Illustrated processing block 258 selects an image from the plurality of images based on the machine learned characteristics. Illustrated processing block 260 sets the selected image as the representative image.

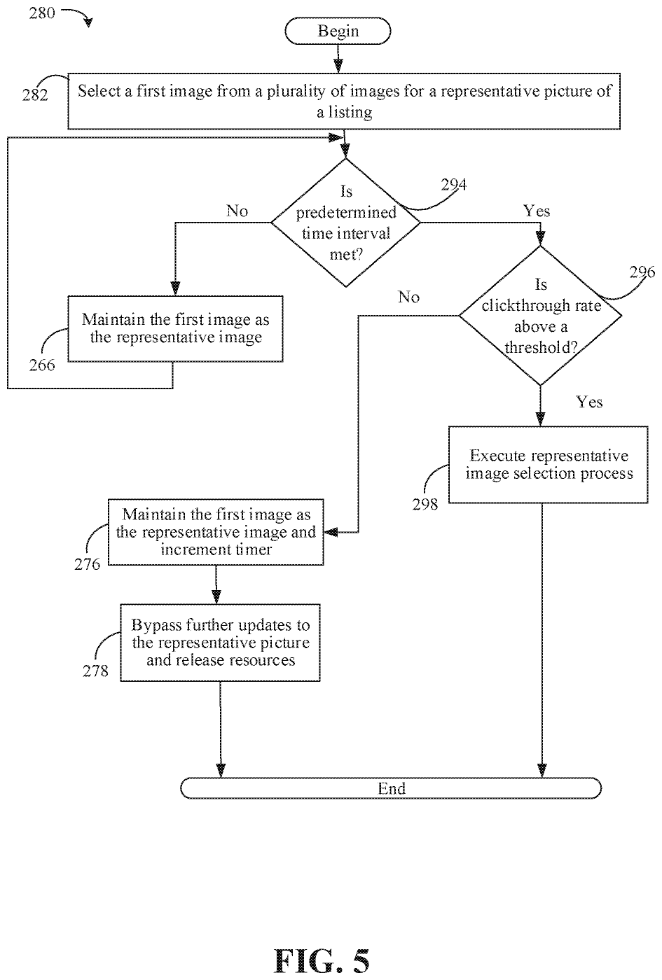

FIG. 5 illustrates a method 280 for determining whether to update a representative image or bypass further analysis to reduce computing resources. One or more aspects of method 280 may be performed by and/or in conjunction with process 100 (FIG. 1), process 158 (FIG. 2), method 200 (FIG. 3) and/or method 250 (FIG. 4) already discussed. Method 280 may be implemented in a computing device, computing system (e.g., hardware, configurable logic, fixed-function logic hardware, at least one computer readable storage medium comprising a set of instructions for execution, etc.).

Illustrated processing block 282 selects a first image from a plurality of images for a representative image for a listing. Illustrated processing block 294 determines if a predetermined time interval has been met. Processing block 294 references a clock to determine whether the time predetermined time interval has been met. If not, illustrated processing block 266 maintains the first image as the representative image.

If the predetermined time interval has been met, illustrated processing block 296 determines if the CTR of the listing is above a threshold. Illustrated processing block 296 may thus determine whether the listing is of interest to users, or is of insufficient interest to bypass updating the listing and preserve computing resources.

If the CTR is above the threshold (e.g., sufficient interest exists to justify allocating computing resources to enhancing the listing), illustrated processing block 298 executes a representative image selection process on the listing. If the CTR is not above the threshold, illustrated processing block 276 maintains the first image as the representative image. Illustrated processing block 278 bypasses further updates to the representative picture and releases resources allocated to the representative image selection (e.g., listing specific timers, storage for the engagement analysis signals and/or image analysis signals) for the listing.

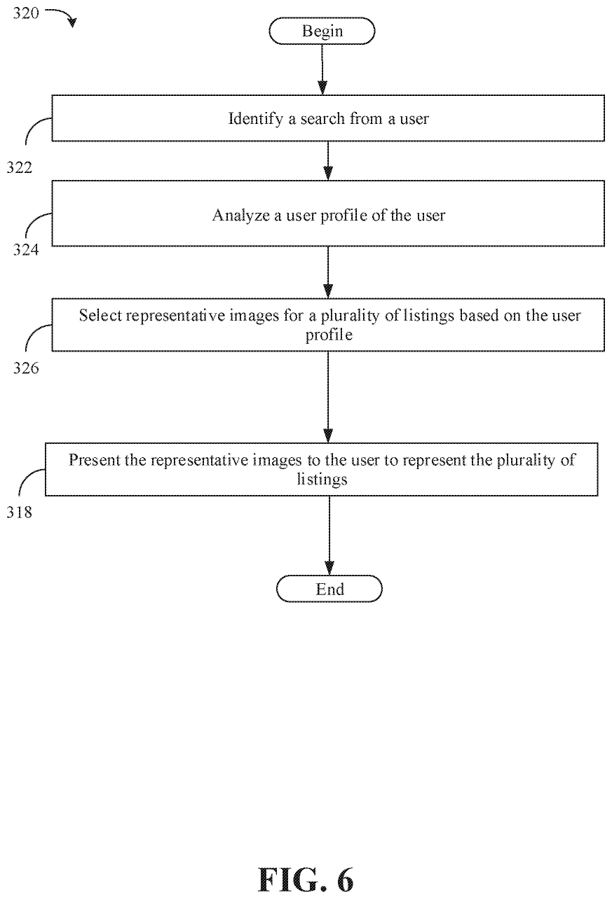

FIG. 6 illustrates a method 320 for selecting a representative image based on a user profile associated with a query. One or more aspects of method 320 may be performed by and/or in conjunction with process 100 (FIG. 1), process 158 (FIG. 2), method 200 (FIG. 3), method 250 (FIG. 4) and/or method 280 (FIG. 5) already discussed. Method 320 may be implemented in a computing device, computing system (e.g., hardware, configurable logic, fixed-function logic hardware, at least one computer readable storage medium comprising a set of instructions for execution, etc.).

Illustrated processing block 322 identifies a search from a user. Illustrated processing block 324 analyzes a user profile of the user. For example, the user may originate the search and a user profile (e.g., historical record of searches and CTRs of images selected by the user) of the user may be detected. The user profile may be analyzed to determine user specific information (e.g., search history, image click-through of other listings, age, demographic information, etc.). Illustrated processing block 326 selects a representing images for a plurality of listings based on the user profile. For example, method 320 determines if the user prefers certain types of pictures (e.g., close-ups, detailed images, certain lighting conditions, color, etc.), and selects those types of images as representative images for listings provided to the user. Furthermore, in some embodiments, demographic wide analysis may be applied. For example, if preferences of previous users within the demographic of the user may be applied to select the representative image. For example, if the user in a demographic, and/or other users from that same demographic clicked on some images of the listings, those images may be selected as representative images. Illustrated processing block 318 presents the representative images to represent the listings.

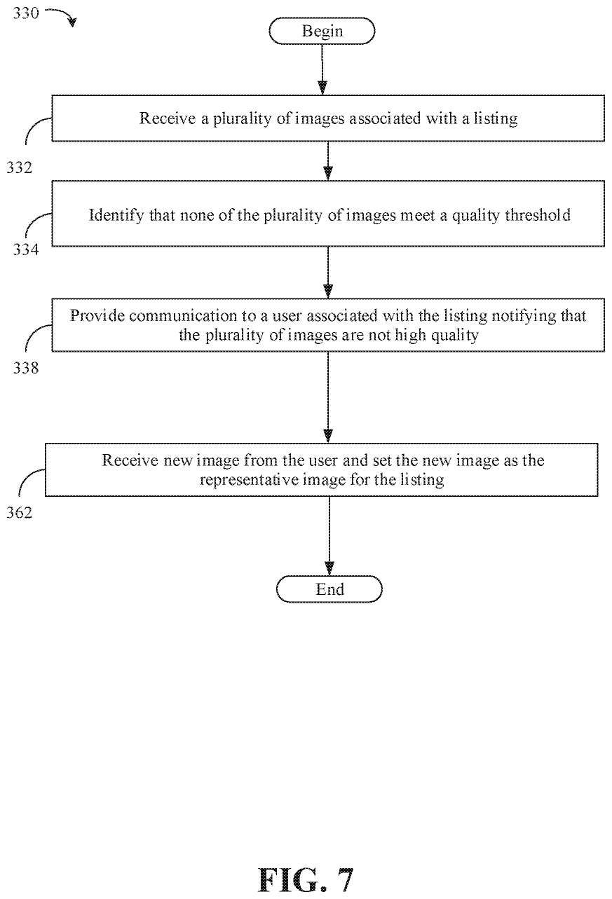

FIG. 7 illustrates a method 330 for requesting new images from a user. One or more aspects of method 280 may be performed by and/or in conjunction with process 100 (FIG. 1), process 158 (FIG. 2), method 200 (FIG. 3), method 250 (FIG. 4), method 280 (FIG. 5) and/or method 320 (FIG. 6) already discussed. Method 330 may be implemented in a computing device, computing system (e.g., hardware, configurable logic, fixed-function logic hardware, at least one computer readable storage medium comprising a set of instructions for execution, etc.).

Illustrated processing block 332 receives a plurality of images associated with a listing. Illustrated processing block 334 identifies that none of the plurality of images meet a quality threshold (e.g., do not correspond to any type of image that has a high CTR, image analysis signals indicate too dark, blurry, not representing important features, etc.). For example, if the user is listing a lamp for sale, but fails to include a type of image with a high CTR (e.g., image with the light of the lamp on), processing block 334 may deem that the plurality of images does not meet the quality threshold. Illustrated processing block 338 provides communication to a user associated with the listing notifying that the plurality of images is not high quality. Illustrated processing block 362 receives a new image from the user and sets the new image as the representative image for the listing.

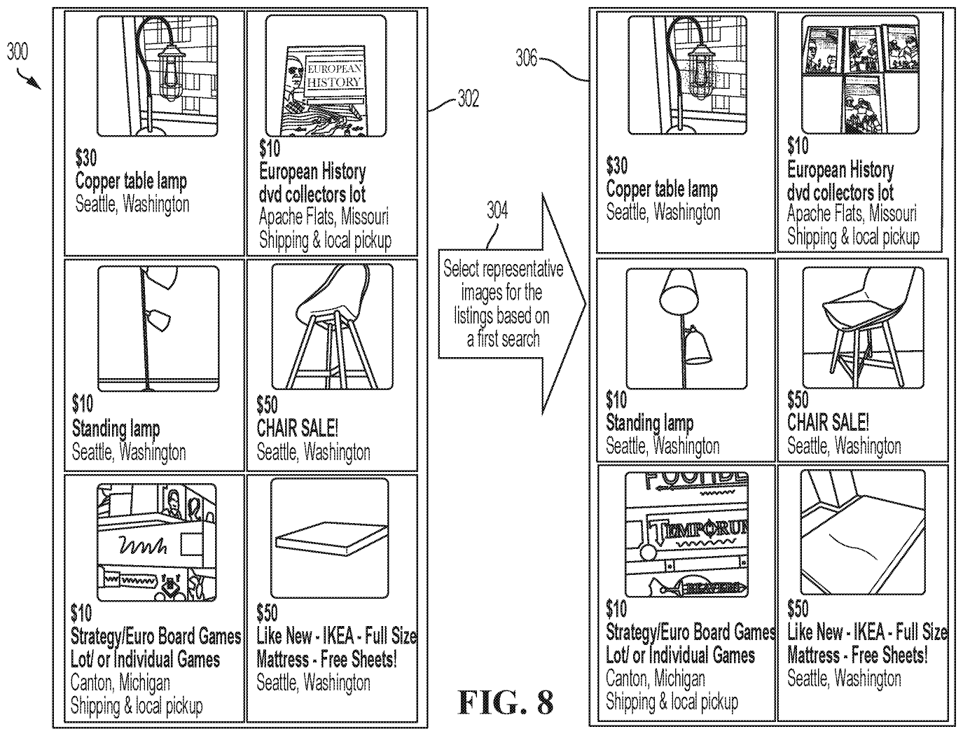

FIG. 8 illustrates a process 300 for selecting images. One or more aspects of process 300 may be performed by and/or in conjunction with process 100 (FIG. 1), process 158 (FIG. 2), method 200 (FIG. 3), method 250 (FIG. 4), method 280 (FIG. 5), method 320 (FIG. 6) and/or method 330 (FIG. 7) already discussed. Process 300 may be implemented in a computing device, computing system (e.g., hardware, configurable logic, fixed-function logic hardware, at least one computer readable storage medium comprising a set of instructions for execution, etc.).

A plurality of representative images 302 for listings are illustrated in a graphical user interface (GUI). Each of the plurality of representative images 302 corresponds to a different listing. If one of the representative images is selected, a corresponding listing may be provided and replaces the plurality of representative images 302 in the GUI.

The process 300 may select different representative images for the listings based on a first search 304. For example, the process 300 may adjust the representative images 302 to the representative images 306 based on a point of origin of the first search, a demographic of a user associated with the first search and/or a one or more key words in the first search. In this example, representative images 302, 306 that are in a same relative location within the GUI are part of the same listing. Thus, the copper table lamp in the upper left of representative images 302, 306 correspond to a same listing, etc.

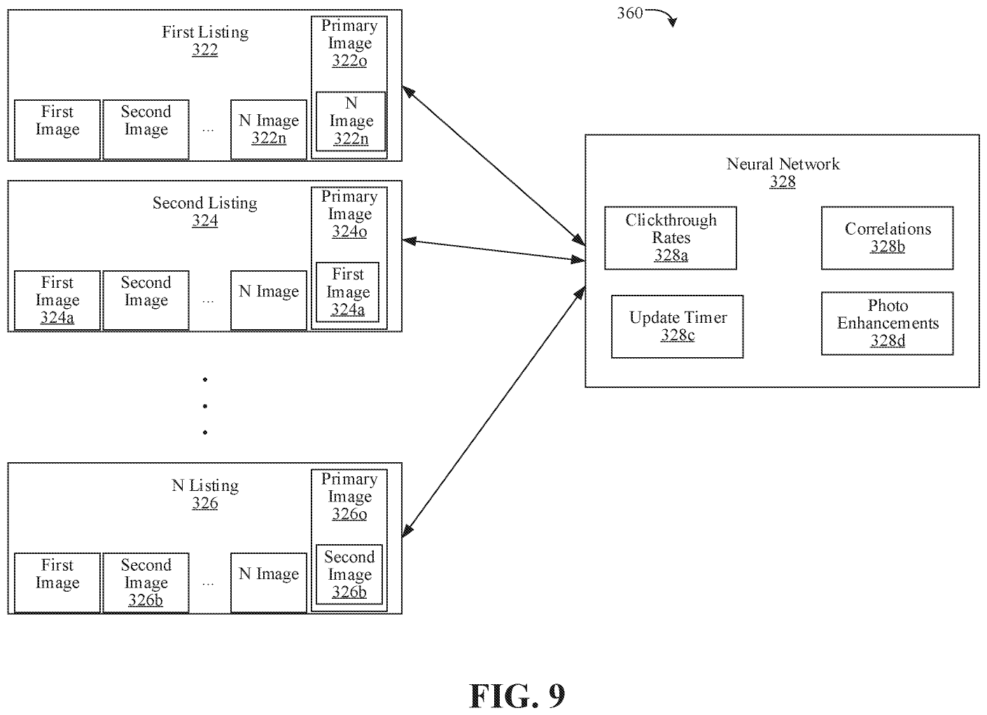

FIG. 9 illustrates a computing architecture 360 to generate representative images and provide listings to a user. The computing architecture 360 may implement one or more aspects of process 100 (FIG. 1), process 158 (FIG. 2), method 200 (FIG. 3), method 250 (FIG. 4), method 280 (FIG. 5) method 320 (FIG. 6), method 330 (FIG. 7) and/or architecture 360 (FIG. 8) already discussed. Architecture 360 may be implemented as a computing device, computing system (e.g., hardware, configurable logic, fixed-function logic hardware, at least one computer readable storage medium comprising a set of instructions for execution, etc.).

In the architecture 360, a neural network 328 is illustrated. The neural network 328 may include a data structure (e.g., a lookup table) to store CTRs 328a. The neural network 328 may further store correlations 328b that stores correlations of images to geographic locations, images to timings of the day, images to demographics, image analysis signals to CTRs 328a, etc. The neural network 328 may also include an update timer 328c that, when expired, triggers an update to representative images. The neural network 328 may also include photo enhancements 328d to enhance photos (e.g., improve clarity, contrast, color, etc.).

When the update timer 328c triggers an update, the neural network 328 may update the representative images. In this example, the neural network 328 may set an N image 322n of a first listing 322 as the primary image 322o (e.g., the representative image), set a first image 324a of a second listing 324 as the primary image 324o (e.g., the representative image), and set a second image 326b of an N listing 326 as the primary image 326o (e.g., the representative image) based on the CTRs 328a and correlations 328b. Additionally, the neural network 328 may enhance the primary images 322o, 324o and 326o with photo enhancement 328d. The neural network may reset and restart the update timer 328c to determine when to update the primary images 322o, 324o and 326o.

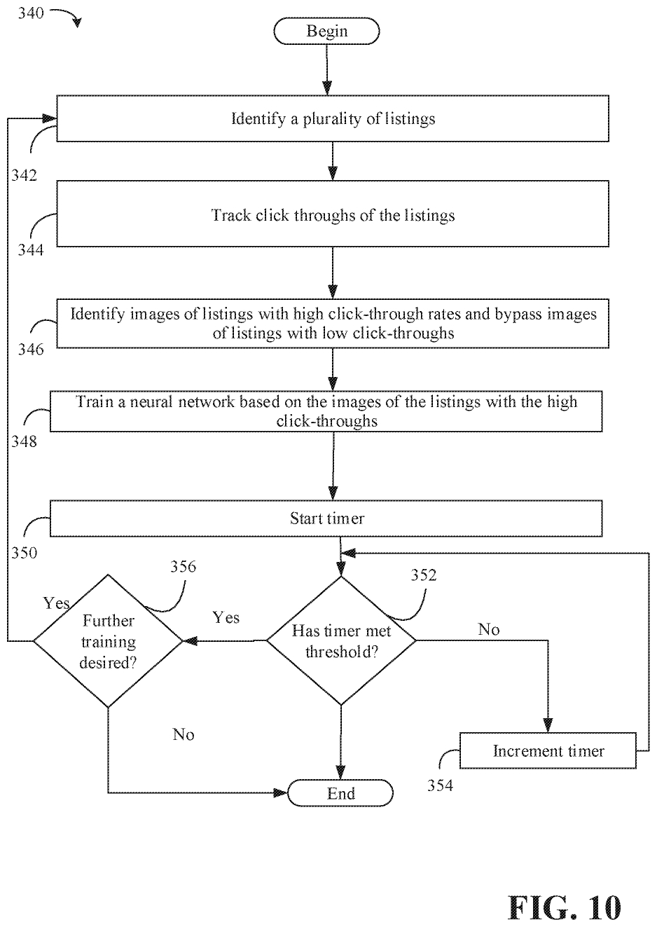

FIG. 10 illustrates a method 340 for periodically updating a neural network training in real-time. One or more aspects of method 340 may be performed by and/or in conjunction with process 100 (FIG. 1), process 158 (FIG. 2), method 200 (FIG. 3), method 250 (FIG. 4), method 280 (FIG. 5) method 320 (FIG. 6), method 330 (FIG. 7), process 300 (FIG. 8) and/or architecture 360 (FIG. 9) already discussed. Method 340 may be implemented in a computing device, computing system (e.g., hardware, configurable logic, fixed-function logic hardware, at least one computer readable storage medium comprising a set of instructions for execution, etc.).

Illustrated processing block 342 identifies a plurality of listings. Illustrated processing block 344 tracks CTRs of the listings and images of the listings. Illustrated processing block 346 identifies images of listings with high CTRs and bypasses images of listings with low CTRs. Illustrated processing block 348 trains a neural network based on the images of the listings with the high CTRs. Illustrated processing block 350 starts a timer. Illustrated processing block 352 determines if the timer has met a threshold. If not, illustrated processing block 354 increments the timer. Otherwise, illustrated processing block 356 determines if further training is desired. For example, if the total amount of listings is below a threshold, further training may not be necessary as the neural network may be successfully identifying representative images to maintain the number listings below a threshold. If however further training is desired, processing block 342 executes.

### System Overview

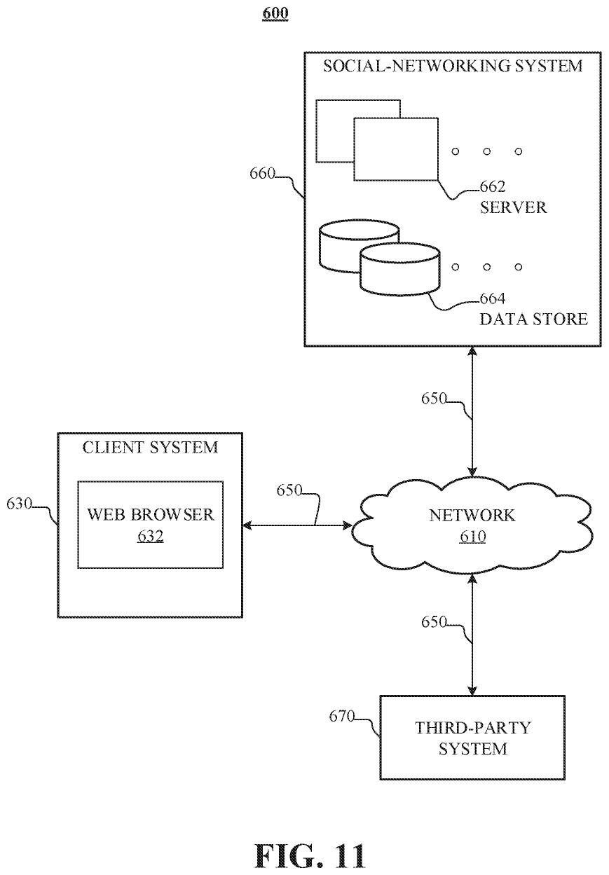

FIG. 11 illustrates an example network environment 600 associated with a social-networking system. Network environment 600 may implement one or more aspects of process 100 (FIG. 1), process 158 (FIG. 2), method 200 (FIG. 3), method 250 (FIG. 4), method 280 (FIG. 5) method 320 (FIG. 6), method 330 (FIG. 7), process 300 (FIG. 8), architecture 360 (FIG. 9) and/or method 340 (FIG. 10).

Network environment 600 includes a client system 630, a social-networking system 660, and a third-party system 670 connected to each other by a network 610. Although FIG. 11 illustrates a particular arrangement of client system 630, social-networking system 660, third-party system 670, and network 610, this disclosure contemplates any suitable arrangement of client system 630, social-networking system 660, third-party system 670, and network 610. As an example and not by way of limitation, two or more of client system 630, social-networking system 660, and third-party system 670 may be connected to each other directly, bypassing network 610. As another example, two or more of client system 630, social-networking system 660, and third-party system 670 may be physically or logically co-located with each other in whole or in part. Moreover, although FIG. 11 illustrates a particular number of client systems 630, social-networking systems 660, third-party systems 670, and networks 610, this disclosure contemplates any suitable number of client systems 630, social-networking systems 660, third-party systems 670, and networks 610. As an example and not by way of limitation, network environment 600 may include multiple client system 630, social-networking systems 660, third-party systems 670, and networks 610.

This disclosure contemplates any suitable network 610. As an example and not by way of limitation, one or more portions of network 610 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 610 may include one or more networks 610.

Links 650 may connect client system 630, social-networking system 660, and third-party system 670 to communication network 610 or to each other. This disclosure contemplates any suitable links 650. In particular embodiments, one or more links 650 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 650 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 650, or a combination of two or more such links 650. Links 650 need not necessarily be the same throughout network environment 600. One or more first links 650 may differ in one or more respects from one or more second links 650.

In particular embodiments, client system 630 may be an electronic device including hardware, software, or embedded logic components or a combination of two or more such components and capable of carrying out the appropriate functionalities implemented or supported by client system 630. As an example and not by way of limitation, a client system 630 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 630. A client system 630 may enable a network user at client system 630 to access network 610. A client system 630 may enable its user to communicate with other users at other client systems 630.

In particular embodiments, client system 630 may include a web browser 632, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 630 may enter a Uniform Resource Locator (URL) or other address directing the web browser 632 to a particular server (such as server 662, or a server associated with a third-party system 670), and the web browser 632 may generate a Hyper Text Transfer Protocol (HTTP) request and communicate the HTTP request to server. The server may accept the HTTP request and communicate to client system 630 one or more Hyper Text Markup Language (HTML) files responsive to the HTTP request. Client system 630 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 660 may be a network-addressable computing system that can host an online social network. Social-networking system 660 may generate, store, receive, and send social-networking data, such as, for example, user-profile data, concept-profile data, social-graph information, or other suitable data related to the online social network. Social-networking system 660 may be accessed by the other components of network environment 600 either directly or via network 610. As an example and not by way of limitation, client system 630 may access social-networking system 660 using a web browser 632, or a native application associated with social-networking system 660 (e.g., a mobile social-networking application, a messaging application, another suitable application, or any combination thereof) either directly or via network 610. In particular embodiments, social-networking system 660 may include one or more servers 662. Each server 662 may be a unitary server or a distributed server spanning multiple computers or multiple datacenters. Servers 662 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 662 may include hardware, software, or embedded logic components or a combination of two or more such components for carrying out the appropriate functionalities implemented or supported by server 662. In particular embodiments, social-networking system 660 may include one or more data stores 664. Data stores 664 may be used to store various types of information. In particular embodiments, the information stored in data stores 664 may be organized according to specific data structures. In particular embodiments, each data store 664 may be a relational, columnar, correlation, or other suitable database. Although this disclosure describes or illustrates particular types of databases, this disclosure contemplates any suitable types of databases. Particular embodiments may provide interfaces that enable a client system 630, a social-networking system 660, or a third-party system 670 to manage, retrieve, modify, add, or delete, the information stored in data store 664.

In particular embodiments, social-networking system 660 may store one or more social graphs in one or more data stores 664. In particular embodiments, a social graph may include multiple nodes—which may include multiple user nodes (each corresponding to a particular user) or multiple concept nodes (each corresponding to a particular concept)—and multiple edges connecting the nodes. Social-networking system 660 may provide users of the online social network the ability to communicate and interact with other users. In particular embodiments, users may join the online social network via social-networking system 660 and then add connections (e.g., relationships) to a number of other users of social-networking system 660 to whom they want to be connected. Herein, the term “friend” may refer to any other user of social-networking system 660 with whom a user has formed a connection, association, or relationship via social-networking system 660.

In particular embodiments, social-networking system 660 may provide users with the ability to take actions on various types of items or objects, supported by social-networking system 660. As an example and not by way of limitation, the items and objects may include groups or social networks to which users of social-networking system 660 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 660 or by an external system of third-party system 670, which is separate from social-networking system 660 and coupled to social-networking system 660 via a network 610.

In particular embodiments, social-networking system 660 may be capable of linking a variety of entities. As an example and not by way of limitation, social-networking system 660 may enable users to interact with each other as well as receive content from third-party systems 670 or other entities, or to allow users to interact with these entities through an application programming interfaces (API) or other communication channels.

In particular embodiments, a third-party system 670 may include one or more types of servers, one or more data stores, one or more interfaces, including but not limited to APIs, one or more web services, one or more content sources, one or more networks, or any other suitable components, e.g., that servers may communicate with. A third-party system 670 may be operated by a different entity from an entity operating social-networking system 660. In particular embodiments, however, social-networking system 660 and third-party systems 670 may operate in conjunction with each other to provide social-networking services to users of social-networking system 660 or third-party systems 670. In this sense, social-networking system 660 may provide a platform, or backbone, which other systems, such as third-party systems 670, may use to provide social-networking services and functionality to users across the Internet.

In particular embodiments, a third-party system 670 may include a third-party content object provider. A third-party content object provider may include one or more sources of content objects, which may be communicated to a client system 630. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 660 also includes user-generated content objects, which may enhance a user's interactions with social-networking system 660. User-generated content may include anything a user can add, upload, send, or “post” to social-networking system 660. As an example and not by way of limitation, a user communicates posts to social-networking system 660 from a client system 630. Posts may include data such as status updates or other textual data, location information, photos, videos, links, music or other similar data or media. Content may also be added to social-networking system 660 by a third-party through a “communication channel,” such as a newsfeed or stream.

In particular embodiments, social-networking system 660 may include a variety of servers, sub-systems, programs, modules, logs, and data stores. In particular embodiments, social-networking system 660 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 660 may also include suitable components such as network interfaces, security mechanisms, load balancers, failover servers, management-and-network-operations consoles, other suitable components, or any suitable combination thereof. In particular embodiments, social-networking system 660 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 660 to one or more client systems 630 or one or more third-party system 670 via network 610. The web server may include a mail server or other messaging functionality for receiving and routing messages between social-networking system 660 and one or more client systems 630. An API-request server may allow a third-party system 670 to access information from social-networking system 660 by calling one or more APIs. An action logger may be used to receive communications from a web server about a user's actions on or off social-networking system 660. In conjunction with the action log, a third-party-content-object log may be maintained of user exposures to third-party-content objects. A notification controller may provide information regarding content objects to a client system 630. Information may be pushed to a client system 630 as notifications, or information may be pulled from client system 630 responsive to a request received from client system 630. Authorization servers may be used to enforce one or more privacy settings of the users of social-networking system 660. A privacy setting of a user determines how particular information associated with a user can be shared. The authorization server may allow users to opt in to or opt out of having their actions logged by social-networking system 660 or shared with other systems (e.g., third-party system 670), such as, for example, by setting appropriate privacy settings. Third-party-content-object stores may be used to store content objects received from third parties, such as a third-party system 670. Location stores may be used for storing location information received from client systems 630 associated with users. Advertisement-pricing modules may combine social information, the current time, location information, or other suitable information to provide relevant advertisements, in the form of notifications, to a user.

Social Graphs

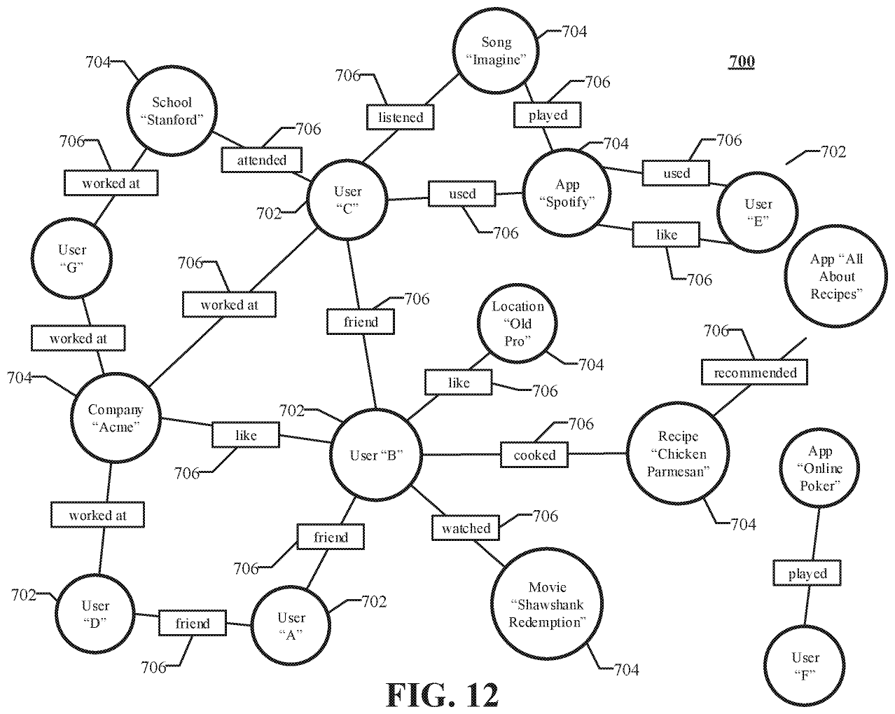

FIG. 12 illustrates example social graph 700. In some embodiments, process 100 (FIG. 1), process 158 (FIG. 2), method 200 (FIG. 3), method 250 (FIG. 4), method 280 (FIG. 5) method 320 (FIG. 6), method 330 (FIG. 7), process 300 (FIG. 8), architecture 360 (FIG. 9) and/or method 340 (FIG. 10) may access social graph 700 to implement one or more aspects.

In particular embodiments, social-networking system 660 may store one or more social graphs 700 in one or more data stores. In particular embodiments, social graph 700 may include multiple nodes—which may include multiple user nodes 702 or multiple concept nodes 704—and multiple edges 706 connecting the nodes. Each node may be associated with a unique entity (i.e., user or concept), each of which may have a unique identifier (ID), such as a unique number or username. Example social graph 700 illustrated in FIG. 12 is shown, for didactic purposes, in a two-dimensional visual map representation. In particular embodiments, a social-networking system 660, client system 630, or third-party system 670 may access social graph 700 and related social-graph information for suitable applications. The nodes and edges of social graph 700 may be stored as data objects, for example, in a data store (such as a social-graph database). Such a data store may include one or more searchable or queryable indexes of nodes or edges of social graph 700.

In particular embodiments, a user node 702 may correspond to a user of social-networking system 660. As an example and not by way of limitation, a user may be an individual (human user), an entity (e.g., an enterprise, business, or third-party application), or a group (e.g., of individuals or entities) that interacts or communicates with or over social-networking system 660. In particular embodiments, when a user registers for an account with social-networking system 660, social-networking system 660 may create a user node 702 corresponding to the user, and store the user node 702 in one or more data stores. Users and user nodes 702 described herein may, where appropriate, refer to registered users and user nodes 702 associated with registered users. In addition or as an alternative, users and user nodes 702 described herein may, where appropriate, refer to users that have not registered with social-networking system 660. In particular embodiments, a user node 702 may be associated with information provided by a user or information gathered by various systems, including social-networking system 660. As an example and not by way of limitation, a user may provide his or her name, profile picture, contact information, birth date, sex, marital status, family status, employment, education background, preferences, interests, or other demographic information. In particular embodiments, a user node 702 may be associated with one or more data objects corresponding to information associated with a user. In particular embodiments, a user node 702 may correspond to one or more webpages.

In particular embodiments, a concept node 704 may correspond to a concept. As an example and not by way of limitation, a concept may correspond to a place (such as, for example, a movie theater, restaurant, landmark, or city); a website (such as, for example, a website associated with social-network system 660 or a third-party website associated with a web-application server); an entity (such as, for example, a person, business, group, sports team, or celebrity); a resource (such as, for example, an audio file, video file, digital photo, text file, structured document, or application) which may be located within social-networking system 660 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 704 may be associated with information of a concept provided by a user or information gathered by various systems, including social-networking system 660. As an example and not by way of limitation, information of a concept may include a name or a title; one or more images (e.g., an image of the cover page of a book); a location (e.g., an address or a geographical location); a web site (which may be associated with a URL); contact information (e.g., a phone number or an email address); other suitable concept information; or any suitable combination of such information. In particular embodiments, a concept node 704 may be associated with one or more data objects corresponding to information associated with concept node 704. In particular embodiments, a concept node 704 may correspond to one or more webpages.

In particular embodiments, a node in social graph 700 may represent or be represented by a webpage (which may be referred to as a “profile page”). Profile pages may be hosted by or accessible to social-networking system 660. Profile pages may also be hosted on third-party websites associated with a third-party system 670. As an example and not by way of limitation, a profile page corresponding to a particular external webpage may be the particular external webpage and the profile page may correspond to a particular concept node 704. Profile pages may be viewable by all or a selected subset of other users. As an example and not by way of limitation, a user node 702 may have a corresponding user-profile page in which the corresponding user may add content, make declarations, or otherwise express himself or herself. As another example and not by way of limitation, a concept node 704 may have a corresponding concept-profile page in which one or more users may add content, make declarations, or express themselves, particularly in relation to the concept corresponding to concept node 704.

In particular embodiments, a concept node 704 may represent a third-party webpage or resource hosted by a third-party system 670. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 630 to send to social-networking system 660 a message indicating the user's action. In response to the message, social-networking system 660 may create an edge (e.g., a check-in-type edge) between a user node 702 corresponding to the user and a concept node 704 corresponding to the third-party webpage or resource and store edge 706 in one or more data stores.

In particular embodiments, a pair of nodes in social graph 700 may be connected to each other by one or more edges 706. An edge 706 connecting a pair of nodes may represent a relationship between the pair of nodes. In particular embodiments, an edge 706 may include or represent one or more data objects or attributes corresponding to the relationship between a pair of nodes. As an example and not by way of limitation, a first user may indicate that a second user is a “friend” of the first user. In response to this indication, social-networking system 660 may send a “friend request” to the second user. If the second user confirms the “friend request,” social-networking system 660 may create an edge 706 connecting the first user's user node 702 to the second user's user node 702 in social graph 700 and store edge 706 as social-graph information in one or more of data stores 664. In the example of FIG. 12, social graph 700 includes an edge 706 indicating a friend relation between user nodes 702 of user “A” and user “B” and an edge indicating a friend relation between user nodes 702 of user “C” and user “B.” Although this disclosure describes or illustrates particular edges 706 with particular attributes connecting particular user nodes 702, this disclosure contemplates any suitable edges 706 with any suitable attributes connecting user nodes 702. As an example and not by way of limitation, an edge 706 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 700 by one or more edges 706. The degree of separation between two objects represented by two nodes, respectively, is a count of edges in a shortest path connecting the two nodes in the social graph 700. As an example and not by way of limitation, in the social graph 700, the user node 702 of user “C” is connected to the user node 702 of user “A” via multiple paths including, for example, a first path directly passing through the user node 702 of user “B,” a second path passing through the concept node 704 of company “Acme” and the user node 702 of user “D,” and a third path passing through the user nodes 702 and concept nodes 704 representing school “Stanford,” user “G,” company “Acme,” and user “D.” User “C” and user “A” have a degree of separation of two because the shortest path connecting their corresponding nodes (i.e., the first path) includes two edges 706.

In particular embodiments, an edge 706 between a user node 702 and a concept node 704 may represent a particular action or activity performed by a user associated with user node 702 toward a concept associated with a concept node 704. As an example and not by way of limitation, as illustrated in FIG. 12, a user may “like,” “attended,” “played,” “listened,” “cooked,” “worked at,” or “watched” a concept, each of which may correspond to an edge type or subtype. A concept-profile page corresponding to a concept node 704 may include, for example, a selectable “check in” icon (such as, for example, a clickable “check in” icon) or a selectable “add to favorites” icon. Similarly, after a user clicks these icons, social-networking system 660 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 660 may create a “listened” edge 706 and a “used” edge (as illustrated in FIG. 12) between user nodes 702 corresponding to the user and concept nodes 704 corresponding to the song and application to indicate that the user listened to the song and used the application. Moreover, social-networking system 660 may create a “played” edge 706 (as illustrated in FIG. 12) between concept nodes 704 corresponding to the song and the application to indicate that the particular song was played by the particular application. In this case, “played” edge 706 corresponds to an action performed by an external application (SPOTIFY) on an external audio file (the song “Imagine”). Although this disclosure describes particular edges 706 with particular attributes connecting user nodes 702 and concept nodes 704, this disclosure contemplates any suitable edges 706 with any suitable attributes connecting user nodes 702 and concept nodes 704. Moreover, although this disclosure describes edges between a user node 702 and a concept node 704 representing a single relationship, this disclosure contemplates edges between a user node 702 and a concept node 704 representing one or more relationships. As an example and not by way of limitation, an edge 706 may represent both that a user likes and has used at a particular concept. Alternatively, another edge 706 may represent each type of relationship (or multiples of a single relationship) between a user node 702 and a concept node 704 (as illustrated in FIG. 12 between user node 702 for user “E” and concept node 704 for “SPOTIFY”).

In particular embodiments, social-networking system 660 may create an edge 706 between a user node 702 and a concept node 704 in social graph 700. As an example and not by way of limitation, a user viewing a concept-profile page (such as, for example, by using a web browser or a special-purpose application hosted by the user's client system 630) may indicate that he or she likes the concept represented by the concept node 704 by clicking or selecting a “Like” icon, which may cause the user's client system 630 to send to social-networking system 660 a message indicating the user's liking of the concept associated with the concept-profile page. In response to the message, social-networking system 660 may create an edge 706 between user node 702 associated with the user and concept node 704, as illustrated by “like” edge 706 between the user and concept node 704. In particular embodiments, social-networking system 660 may store an edge 706 in one or more data stores. In particular embodiments, an edge 706 may be automatically formed by social-networking system 660 in response to a particular user action. As an example and not by way of limitation, if a first user uploads a picture, watches a movie, or listens to a song, an edge 706 may be formed between user node 702 corresponding to the first user and concept nodes 704 corresponding to those concepts. Although this disclosure describes forming particular edges 706 in particular manners, this disclosure contemplates forming any suitable edges 706 in any suitable manner.

Social Graph Affinity and Coefficient

In particular embodiments, social-networking system 660 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 670 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 660 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 660 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 660 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 660 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 660 may calculate a coefficient based on a user's actions. Social-networking system 660 may monitor such actions on the online social network, on a third-party system 670, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 660 may calculate a coefficient based on the user's actions with particular types of content. The content may be associated with the online social network, a third-party system 670, or another suitable system. The content may include users, profile pages, posts, news stories, headlines, instant messages, chat room conversations, emails, advertisements, pictures, video, music, other suitable objects, or any combination thereof. Social-networking system 660 may analyze a user's actions to determine whether one or more of the actions indicate an affinity for subject matter, content, other users, and so forth. As an example and not by way of limitation, if a user frequently posts content related to “coffee” or variants thereof, social-networking system 660 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 660 may calculate a coefficient based on the type of relationship between particular objects. Referencing the social graph 700, social-networking system 660 may analyze the number and/or type of edges 706 connecting particular user nodes 702 and concept nodes 704 when calculating a coefficient. As an example and not by way of limitation, user nodes 702 that are connected by a spouse-type edge (representing that the two users are married) may be assigned a higher coefficient than user nodes 702 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 660 may determine that the user has a higher coefficient with respect to the first photo than the second photo because having a tagged-in-type relationship with content may be assigned a higher weight and/or rating than having a like-type relationship with content. In particular embodiments, social-networking system 660 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 660 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 700. As an example and not by way of limitation, social-graph entities that are closer in the social graph 700 (i.e., fewer degrees of separation) may have a higher coefficient than entities that are further apart in the social graph 700.

In particular embodiments, social-networking system 660 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 630 of the user). A first user may be more interested in other users or concepts that are closer to the first user. As an example and not by way of limitation, if a user is one mile from an airport and two miles from a gas station, social-networking system 660 may determine that the user has a higher coefficient for the airport than the gas station based on the proximity of the airport to the user.

In particular embodiments, social-networking system 660 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 660 may provide information that is relevant to user's interests and current circumstances, increasing the likelihood that they will find such information of interest. In particular embodiments, social-networking system 660 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 660 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 660 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 670 (e.g., via an API or other communication channel), or from another suitable system. In response to the request, social-networking system 660 may calculate the coefficient (or access the coefficient information if it has previously been calculated and stored). In particular embodiments, social-networking system 660 may measure an affinity with respect to a particular process. Different processes (both internal and external to the online social network) may request a coefficient for a particular object or set of objects. Social-networking system 660 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

Privacy

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 704 corresponding to a particular photo may have a privacy setting specifying that the photo may only be accessed by users tagged in the photo and their friends. In particular embodiments, privacy settings may allow users to opt in or opt out of having their actions logged by social-networking system 660 or shared with other systems (e.g., third-party system 670). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 670, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 662 may be authorization/privacy servers for enforcing privacy settings. In response to a request from a user (or other entity) for a particular object stored in a data store 664, social-networking system 660 may send a request to the data store 664 for the object. The request may identify the user associated with the request and may only be sent to the user (or a client system 630 of the user) if the authorization server determines that the user is authorized to access the object based on the privacy settings associated with the object. If the requesting user is not authorized to access the object, the authorization server may prevent the requested object from being retrieved from the data store 664, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

Systems and Methods

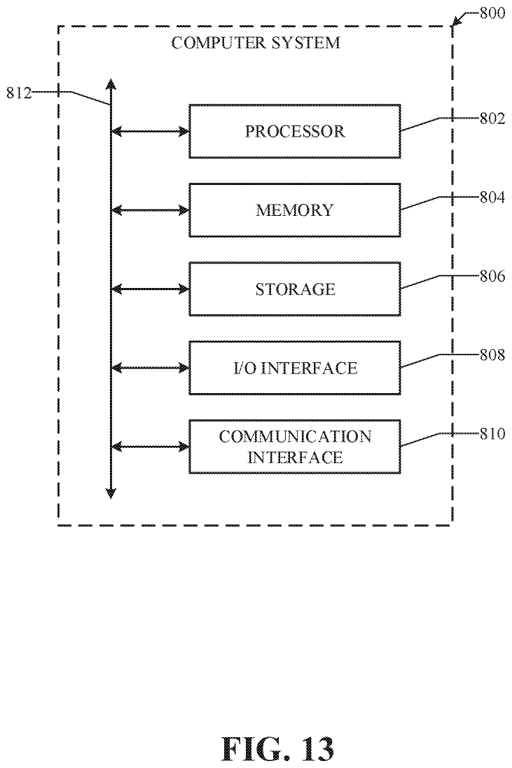

FIG. 13 illustrates an example computer system 800. The system 800 may implement one or more aspects of process 100 (FIG. 1), process 158 (FIG. 2), method 200 (FIG. 3), method 250 (FIG. 4), method 280 (FIG. 5) method 320 (FIG. 6), method 330 (FIG. 7), process 300 (FIG. 8), architecture 360 (FIG. 9) and/or method 340 (FIG. 10). In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Thus, technology described herein may support a granular image enhancement selection process. The technology may substantially reduce the memory needed to store listings, the time needed to consummate a transaction and preserve valuable compute resources as well as bandwidth.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SOCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1. At least one non-transitory computer readable storage medium comprising a set of instructions, which when executed by a computing device, cause the computing device to:
identify a plurality of images associated with a first listing;
identify a time of day;
identify that the time of day is within a first time period;
select a first set of engagement analysis signals that corresponds to the first time period;
select a first image from the plurality of images based on the first set of engagement analysis signals, wherein at least one engagement analysis signal of the first set of engagement analysis signals is associated with click-through rates of a first plurality of listings; and
set the first image as a representative image based on the selection of the first image, wherein the representative image represents the first listing.

2. The at least one non-transitory computer readable storage medium of claim 1, wherein the instructions, when executed, cause the computing device to:
in response to a predetermined time interval being reached, select a second image of the plurality of images to replace the first image as the representative image, based on the first set of engagement analysis signals.

3. The at least one non-transitory computer readable storage medium of claim 1, wherein the instructions, when executed, cause the computing device to:
identify a query associated with a user;
identify one or more characteristics associated with the user, wherein the one or more characteristics include one or more of an age of the user, interests of the user, a geographic location of the user or a search history of the user; and
adjust the first set of engagement analysis signals based on the one or more characteristics.

4. The at least one non-transitory computer readable storage medium of claim 1, wherein the instructions, when executed, cause the computing device to:
identify text associated with the first listing; and
adjust the first set of engagement analysis signals based on the text.

5. The at least one non-transitory computer readable storage medium of claim 1, wherein the instructions, when executed, cause the computing device to:
identify a click-through rate associated with each of the plurality of images; and
select the first image based on the click-through rates of the plurality of images.

6. The at least one non-transitory computer readable storage medium of claim 1, wherein the instructions, when executed, cause the computing device to:
identify one or more characteristics of the plurality of images;
generate at least one image analysis signal based on the one or more characteristics of the plurality of images; and
select the first image further based on the at least one image analysis signal.

7. The at least one non-transitory computer readable storage medium of claim 1, wherein the instructions, when executed, cause the computing device to:
identify whether a click-through rate associated with the first listing is above a threshold;
in response to the click-through rate of the first listing being above the threshold, set a second image from the plurality of images as the representative image; and
in response to the click-through rate of the first listing being below the threshold, bypass modification to the representative image.

8. A system comprising:
a network controller that receives a first plurality of listings and a first listing;
one or more processors; and
a memory coupled to the processors, the memory comprising instructions executable by the one or more processors, the one or more processors being operable when executing the instructions to:
identify a plurality of images associated with the first listing;
identify a time of day;
identify that the time of day is within a first time period;
select a first set of engagement analysis signals that corresponds to the first time period;
select a first image from the plurality of images based on the first set of engagement analysis signals, wherein at least one engagement analysis signal of the first set of engagement analysis signals is associated with click-through rates of the first plurality of listings; and
set the first image as a representative image based on the selection of the first image, wherein the representative image represents the first listing.

9. The system of claim 8, wherein the one or more processors are further operable when executing the instructions to:
in response to a predetermined time interval being reached, select a second image of the plurality of images to replace the first image as the representative image, based on the first set of engagement analysis signals.

10. The system of claim 8, wherein the one or more processors are further operable when executing the instructions to:
identify a query associated with a user;
identify one or more characteristics associated with the user, wherein the one or more characteristics include one or more of an age of the user, interests of the user, a geographic location of the user or a search history of the user; and
adjust the first set of engagement analysis signals based on the one or more characteristics.

11. The system of claim 8, wherein the one or more processors are further operable when executing the instructions to:
identify text associated with the first listing; and
adjust the first set of engagement analysis signals based on the text.

12. The system of claim 8, the one or more processors further operable when executing the instructions to:
identify a click-through rate associated with each of the plurality of images; and
select the first image based on the click-through rates of the plurality of images.

13. The system of claim 8 wherein the one or more processors are further operable when executing the instructions to:
identify one or more characteristics of the plurality of images;
generate at least one image analysis signal based on the one or more characteristics of the plurality of images; and
select the first image further based on the at least one image analysis signal.

14. The system of claim 8, wherein the one or more processors are further operable when executing the instructions to:
identify whether a click-through rate associated with the first listing is above a threshold;
in response to the click-through rate of the first listing being above the threshold, set a second image from the plurality of images as the representative image; and
in response to the click-through rate of the first listing being below the threshold, bypass modification to the representative image.

15. A method comprising:
identifying a plurality of images associated with a first listing;
identifying a time of day;
identifying that the time of day is within a first time period;
selecting a first set of engagement analysis signals that corresponds to the first time period;
selecting a first image from the plurality of images based on the first set of engagement analysis signals, wherein at least one engagement analysis signal of the first set of engagement analysis signals is associated with click-through rates of a first plurality of listings; and
setting the first image as a representative image based on the selection of the first image, wherein the representative image represents the first listing.

16. The method of claim 15, further comprising:
in response to a predetermined time interval being reached, selecting a second image of the plurality of images to replace the first image as the representative image, based on the first set of engagement analysis signals.

17. The method of claim 15, further comprising:
identifying a query associated with a user;
identifying one or more characteristics associated with the user, wherein the one or more characteristics include one or more of an age of the user, interests of the user, a geographic location of the user or a search history of the user; and
adjusting the first set of engagement analysis signals based on the one or more characteristics.

18. The method of claim 15, further comprising:
identifying text associated with the first listing; and
adjusting the first set of engagement analysis signals based on the text.

19. The method of claim 15, further comprising:
identifying a click-through rate associated with each of the plurality of images; and
selecting the first image based on the click-through rates of the plurality of images.

20. The method of claim 15, further comprising:
identifying one or more characteristics of the plurality of images;
generating at least one image analysis signal based on the one or more characteristics of the plurality of images; and
selecting the first image further based on the at least one image analysis signal.
